(19) United States
(12) Patent Application Publication
(10) Pub. No.: US 2013/0179326 A1
(43) Pub. Date: Jul. 11, 2013

(54) SYSTEM, PROGRAM PRODUCT AND METHOD FOR INITIATING A CREDIT CARD ACCOUNT

(71) Applicants: MILES BEACOM, SIOUX FALLS, SD (US); DARRIN GRAHAM, SIOUX FALLS, SD (US); LISA IRVINE, SIOUX FALLS, SD (US); SUE QUANBECK ETTEN, SIOUX FALLS, SD (US); GINA BEERS, SIOUX FALLS, SD (US); EASTLYN CARSON, SIOUX FALLS, SD (US)

(72) Inventors: MILES BEACOM, SIOUX FALLS, SD (US); DARRIN GRAHAM, SIOUX FALLS, SD (US); LISA IRVINE, SIOUX FALLS, SD (US); SUE QUANBECK ETTEN, SIOUX FALLS, SD (US); GINA BEERS, SIOUX FALLS, SD (US); EASTLYN CARSON, SIOUX FALLS, SD (US)

(21) Appl. No.: 13/625,092

(22) Filed: Sep. 24, 2012

Related U.S. Application Data
(60) Provisional application No. 61/584,442, filed on Jan. 9, 2012.

(51) Int. Cl. G06Q 40/02

(52) U.S. Cl. 705/38

(57) ABSTRACT

A system, program product and method for initiating a credit card account may comprise receiving an application from an applicant, conducting an approval process on the application, approving the application including assembling data in a credit card database without opening the credit card account, notifying the applicant of the approval, and providing a credit card object for the credit card account to the applicant. The method may further include requiring further action to be taken by the applicant before opening the credit card account, determining if the required further action has been taken by the applicant, and if determined so, opening the credit card account of the applicant to enable use of the credit card object to utilize the credit card account. The required further action may be payment of a required amount.

### BACKGROUND

### Field

The present disclosure relates to credit card operations and more particularly pertains to a new system, program product and method for initiating a credit card account which provides greater incentive to credit card issuers to issue credit card products to less credit-worthy individuals of greater risk, and also provides additional motivation to the credit card account applicant to complete the credit card process.

### SUMMARY

In one aspect, the present disclosure relates to a method of initiating a credit card account by a financial institution for an applicant. The method may comprise receiving an application from an applicant for a credit card account, conducting an approval process on the application of the applicant for the credit card account, and approving the application of the applicant for the credit card account. Approving the application may include assembling data corresponding to the applicant in a credit card database without opening the credit card account. The method may further include notifying the applicant of the approval of the applicant for the credit card account, providing a credit card object associated with the credit card account to the applicant prior to opening the credit card account, and requiring further action to be taken by the applicant before opening the credit card account after notifying the applicant of the approved application for the credit card account. The method may further include determining if the required further action has been taken by the applicant, and if the required further action has been taken by the applicant, opening the credit card account of the applicant to enable use of the credit card object to utilize the credit card account.

In another aspect, the present disclosure relates to a computer program product stored on a tangible computer memory media associated with a first computer and operable on the first computer, with the computer program product including instructions executable by the first computer to cause the first computer to perform steps including receiving an application from an applicant for a credit card account, and if the application is approved for the credit card account, assembling data corresponding to the applicant in a credit card database without opening the credit card account. The steps may also include transmitting a notification to the applicant of the approval of the applicant for the credit card account, wherein the notification includes identification of a further action to be taken by the applicant before the credit card account is opened, and causing a credit card object associated with the credit card account to be transmitted to the applicant prior to opening the credit card account. The steps may further include determining if the required further action has been taken by the applicant, and if the required further action has been taken by the applicant, opening the credit card account of the applicant to enable use of the credit card object to utilize the credit card account.

In still another aspect, the disclosure relates to a system for initiating a credit card account by a financial institution for an applicant. The system may comprise a first computer associated with the financial institution, with the first computer being communicatively connected to a computer communications network. The first computer includes a processor and memory. The system may also comprise a computer program product stored on a tangible computer memory media associated with the first computer and operable on at least the first computer. The computer program product may include instructions executable by at least the first computer to cause the first computer to perform the steps of receiving an application from an applicant for a credit card account, and if the application is approved for the credit card account, assembling data corresponding to the applicant in a credit card database without opening the credit card account. The steps may further include transmitting a notification to the applicant of the approval of the applicant for the credit card account, and wherein the notification includes identification of a further action to be taken by the applicant before the credit card account is opened. The steps may also include causing a credit card object associated with the credit card account to be transmitted to the applicant prior to opening the credit card account, determining if the required further action has been taken by the applicant, and if the required further action has been taken by the applicant, opening the credit card account of the applicant to enable use of the credit card object to utilize the credit card account.

There has thus been outlined, rather broadly, some of the more important elements of the disclosure in order that the detailed description thereof that follows may be better understood, and in order that the present contribution to the art may be better appreciated. There are additional elements and aspects of the disclosure that will be described hereinafter and which will form the subject matter of the claims appended hereto.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic flow diagram of one illustrative implementation of a new method for initiating a credit card account according to the present disclosure.

FIG. 2 is a schematic flow diagram of a portion of the illustrative implementation of the method depicting some aspects in greater detail.

FIG. 3 is a schematic diagram of a program product stored in memory and executable by a computer according to an embodiment of the present disclosure.

FIG. 4 is a schematic diagram of various elements of the system of the disclosure, according to an illustrative embodiment.

### DETAILED DESCRIPTION

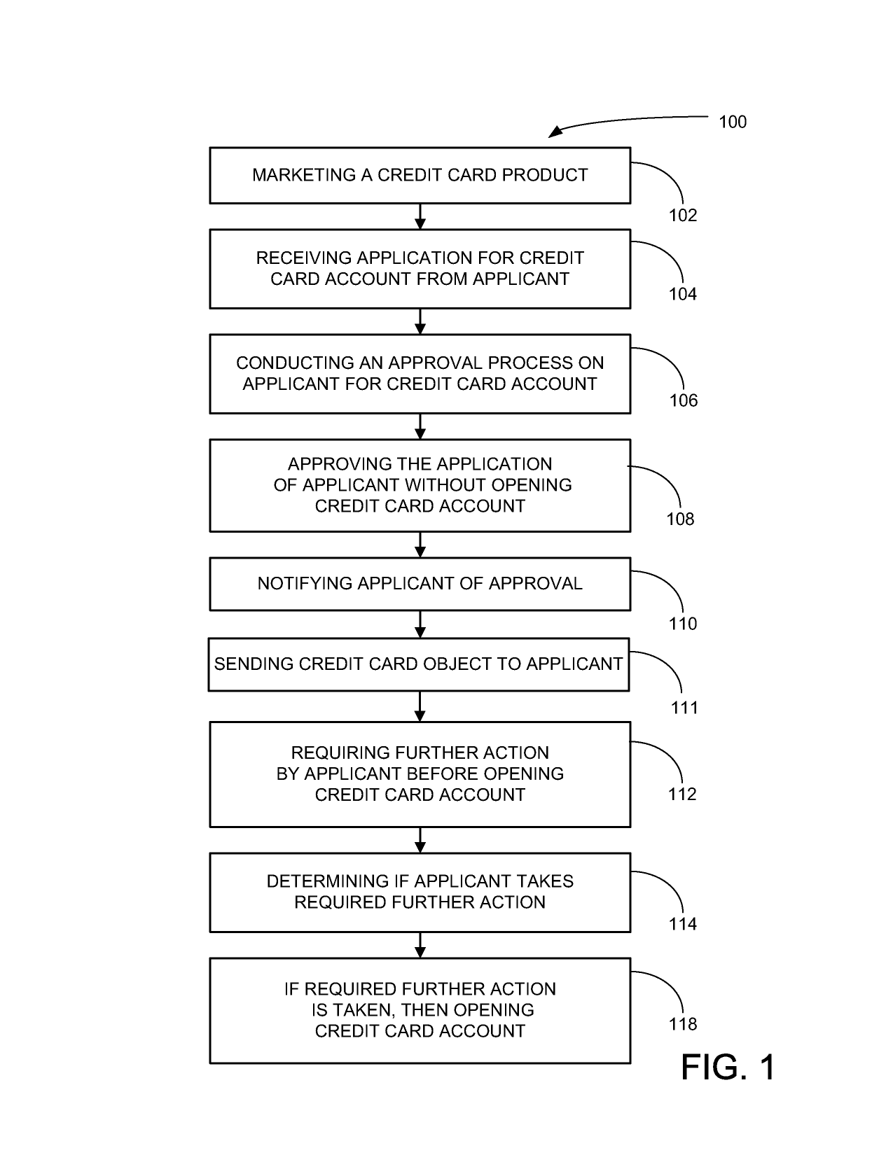

With reference now to the drawings, and in particular to FIGS. 1 through 4 thereof, a new system, program product and method for initiating a credit card account embodying the principles and concepts of the disclosed subject matter will be described.

A conventional credit card application and issuance process typically involves an applicant completing and submitting an application for the credit card account to a bank, and the financial institution or bank performs an approval process, and upon approval of the customer for the credit card, the bank opens the credit card account and it provides the credit card object to the customer, usually by mailing the credit card object to the applicant. Under this conventional scenario, the amount of fees that may be charged to the customer after the opening of the account and mailing of the card may be limited by government and Federal Reserve rules and regulations imposed upon entities that issue credit cards and maintain credit card accounts. For example, under the Credit Card Accountability Responsibility and Disclosure (CARD) Act of 2009, restrictions were placed on some of the fees that could be charged credit cardholders by the credit card issuing entities. Some of the restrictions placed on the fees that may be charged have limited the ability of the card issuing entities to offer and provide credit card accounts to less credit-worthy individuals where the risk involved in providing credit is relatively higher, and may not be justified by the relatively lower level of fees that can be charged.

The inventors have recognized problems that may be encountered in attempting to offer and provide credit card products in the regulatory environment presented by the CARD act as well as other related laws and regulations. The inventors have developed a process for offering and opening credit cards that is different from conventional credit card issuance processes and is advantageous in that it provides greater incentive to credit card issuers to provide credit card products to less credit-worthy individuals which requires accepting greater risk, and may also provide additional motivation to the credit card account applicant to complete the credit card initiation process.

More specifically, the inventors have recognized that some of the increased risk represented by issuing credit card accounts to less credit-worthy individuals may be offset by charging an amount such as an activation fee to the credit card account applicant prior to, and as a condition precedent to, opening or activating the credit card account, which may not fall under some of the restrictions placed upon fees that may be charged by credit card issuing entities to credit card account holders. Further, the inventors have recognized that an applicant who has been approved for the credit card account but has yet to pay the required amount (e.g., such as an activation fee and/or a collateral deposit) to open the credit card account may be further incentivized to pay the required amount in a timely manner by providing the applicant with the credit card object after the applicant has been approved but prior to the card account being opened. This process may allow the credit card holder to utilize the credit card account relatively sooner after the account is opened, rather than waiting for the card to be received in the mail after approval and opening of the card account has been accomplished. Also, the applicant may be more favorably disposed to pay the required amount to open the credit card account if the applicant has actual physical possession of the credit card object which may be utilized to obtain credit simply upon the payment of the required amount.

In one aspect, the disclosure relates to methods of initiating a credit card account 10, and in particular the opening of the account, by a financial institution 12 such as a bank, for an applicant 14 for the card account 10. The methods may also relate to the manner in which the credit card object 16 is provided to an applicant that has been approved and the manner in which the credit card account may be opened for use.

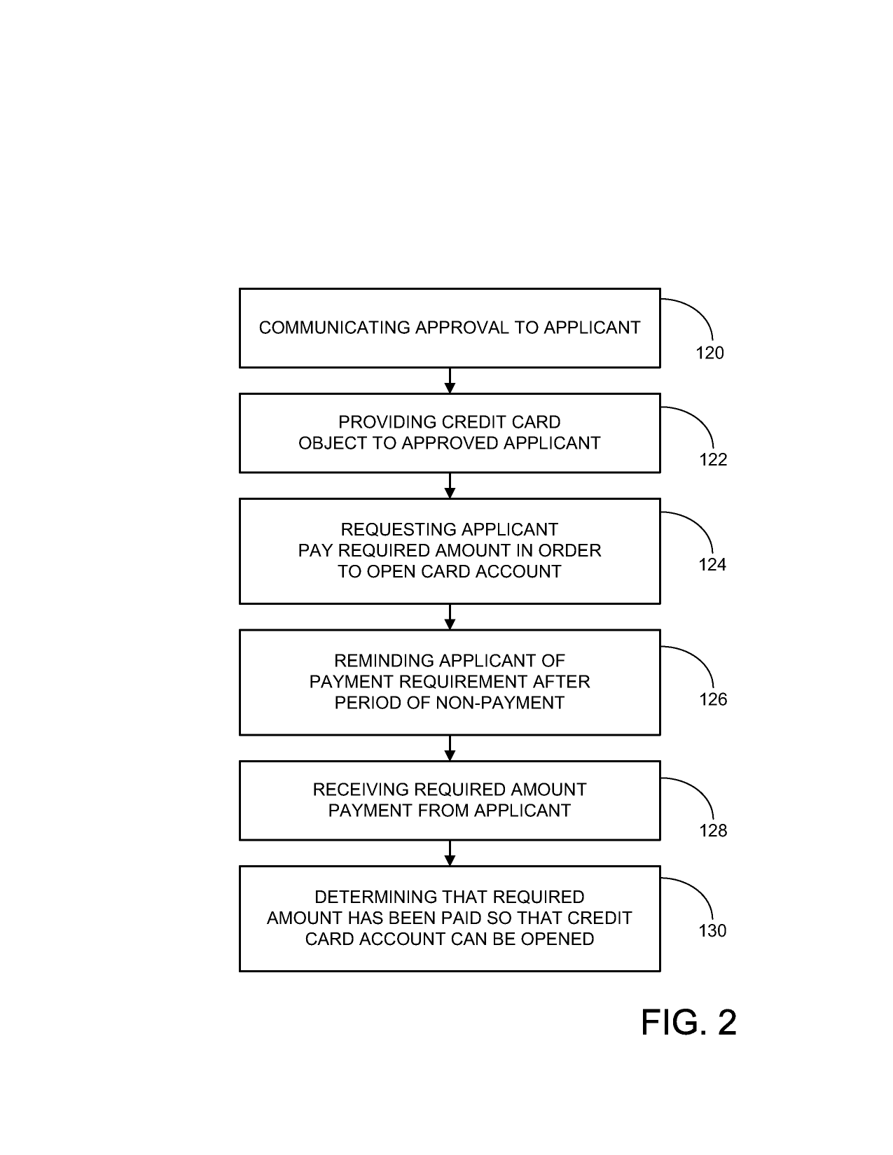

An illustrative implementation of the methods of the disclosure is shown by process 100 in FIGS. 1 and 2. The process 100 may include preliminary aspects of the offering of one or more credit card products to potential customers, including, for example, marketing the credit card product or products (block 102) which may further include informing potential customers of the relevant aspects of the credit card product, such as terms and conditions placed upon the approval and usage of the credit card account.

The process 100 may also include the receiving of an application 18 from the applicant 14 for consideration for opening a credit card account 10 (block 104). In general, an application may be a request by a consumer for a credit card account from the financial institution in which the consumer (or applicant) has provided all of the information necessary for the institution to make a credit decision based on the institution's predetermined criteria, other than information the institution may obtain from third parties. The request for credit may be considered an “application” from the time all of the information the applicant is required to provide has been provided to the institution until the time the request is approved, or the request is withdrawn or declined. The application may be received by any suitable manner for transmission, including an electronic application form received via a computer communication network 20, a verbal application received via a telephone communication network, or a completed paper application form received via postal mail or courier. In some implementations of the process 100, an application fee 22 may be required to be paid for consideration of the credit card account application, although such a fee is not critical to the present process. Optionally, the application, in whatever form received, may be reviewed for suitability for further consideration, including determining if the information in the application is complete, and the particular applicant is not listed on a database that would not allow the applicant to be eligible for the credit card product, such as, for example, the listing maintained by the Office of Foreign Assets Control (OFAC) agency of the U.S. Treasury Department, as well as any other private or proprietary disqualification lists.

An approval process may be conducted on the application of the applicant (block 106), which may include various steps for underwriting and determining acceptability of the applicant for the credit card product to which the application is directed. The process for approving the application may include, for example, checking any credit history record for the applicant, comparing the credit attributes of the applicant to a credit model or threshold criteria for approving a credit card account application, as well as any other criteria or tests. If the applicant does not meet the underwriting requirements, threshold criteria or scoring based upon a combination of requirements, then the application may be denied and the applicant notified of the denial and the reason or reasons for denial. The process 100 does not further involve those applicants denied a credit card account.

If the approval process indicates that the applicant is suitable for the credit card product and is eligible to open a credit card account, then the application of the applicant may be approved (block 108) for the credit card product. In general, an approval occurs when the institution determines that all of the criteria to obtain the requested credit card account have been satisfied or waived, except in most implementations the requirements for opening the card account. The financial institution communicates the approval to the applicant, and the request for credit may be considered an “approval” from the time the institution notifies the applicant of the approval of the application until the card account is opened, or the request for credit is withdrawn, either expressly or by the passage of time without satisfaction of the requirements for opening the card account. In many of the most preferred implementations, the applicant may be approved for the credit card product without a credit card account being opened for the applicant, and the account opening may be conditioned upon the applicant taking further actions described herein. Upon approval of the applicant for a card account, a record 24 for the applicant may be created in a credit card account database 26, and data for the record may be collected and assembled including relevant and required information such as, for example, the name and address of the account applicant, and an identifier associated with a credit card account. Although some aspects of the credit card account may be established through the actions of the credit card issuer, the credit card account is not opened and any credit represented by the unopened account cannot be accessed or used by the applicant. Conducting the approval step and steps for data recordation prior to notification of the applicant may facilitate and thus quicken the opening of the credit card account for use later in the process after the applicant acts, although the account establishment steps are not necessarily taken prior to applicant notification.

The process 10 may further include notifying the applicant of the approval of the applicant's application for the credit card account (block 110). A notification 28 may be transmitted to the approved applicant by any suitable means such as by electronic message, telephonic communication, postal mail or status posting on a website accessible by the applicant, as well as other means. Notifying the applicant may be conducted after the applicant's application has been approved but before the credit card account has been opened or activated for use. The credit card object may be mailed or otherwise transmitted to the applicant (block 111) after the approval of the applicant, but may be prior to the opening of the credit card account. Opening of the credit card account may be conditioned upon the applicant for the credit card product taking further and specific actions after the applicant's application has been approved (block 112), and will be described in greater detail now in connection with the illustrative showing in FIG. 2 of the drawings. In other words, the opening of the credit card account may be deferred after approval until the applicant takes the necessary action or actions.

Looking now to FIG. 2 in which some aspects of the illustrative process 100 depicted in FIG. 1 are shown, the process may include, after communicating the approval of the application to the applicant (block 120), the step of providing a credit card object associated with the approved credit card account to the applicant (block 122), and this may occur prior to opening the credit card account represented by the credit card object provided to the applicant. The approved applicant thus may have possession of the physical credit card object 16 prior to opening of the credit card account. The credit card object 16 may be the physical representation of the credit card account, typically a small plastic plate or card having information about the credit card account printed and/or encoded on the card so that the information may be read from the card either visually, tactilely or electronically. Sending of the credit card object to the applicant may be any suitable means, but typically involves sending the credit card object to the applicant (at a location often remote from the financial institution or bank issuing the card) by postal mail or other suitable courier. As possession of the credit card object does not permit the user to utilize the unopened credit card account, the notification may make this limitation clear in the context of explaining the steps to be taken to open the card account.

Opening of the credit card account may require further action to be taken by the approved applicant. In general, the opening of the card account occurs at or near the time that the applicant satisfies any and all conditions for opening the credit card account (or the conditions are waived), and the applicant is first able to use the credit card account for transactions. In many of the most preferred implementations of the process, the conditions include one or more further required actions, which may include full payment of any required amount 30. The required amount may comprise, for example, an activation fee due to the financial institution to open the account, a collateral deposit to secure the card account, or both, as well as other required amounts or payments. In most implementations, the further required action is not merely the act of notifying the financial institution or card issuer that the credit card object has been received by the applicant. The process 100 may include requesting payment of the required amount from the applicant to open the credit card account (block 124). The request for payment of the required amount may be made in conjunction with providing the credit card object to the applicant, or just before or just after. Providing the credit card object in a close temporal relationship to the request for payment of the required amount, so that the applicant has possession of the credit card object when the request is made, may be desirable and beneficial to motivate the applicant to make the required amount payment in an expeditious manner. In some implementations, the applicant may not be permitted to pay the required amount before the application is approved, or before the applicant receives the credit card object.

The mode of communication of the notification may vary. For example, if the credit card account application was transmitted by the applicant to the financial institution via the computer communication network, a notification message may be transmitted with notification of the approval over the computer communication network to the applicant, and may comprise an email notification. If the applicant's application was received via the telephone communication network, a notification message with notification of the approval may be transmitted over the telephone communication network by a representative of the financial institution by a telephone call or message. If the application was transmitted by the applicant via postal mail, a notification message with notification of the approval may be mailed to the applicant. However, the mode of communicating the notification is not limited to the particular mode through which the original application was communicated.

In connection with the request for payment of the required amount, the applicant may also be notified of a predetermined activation period for the applicant to make payment of the required amount to open the credit card account. The applicant may also be notified that the approval of the application may be withdrawn if the required amount is not paid within the predetermined activation period. The predetermined activation period may be a period of days, and in some implementations of the process, the period of days may be from approximately 60 days to approximately 120 days, and in some implementations the period of days may be from approximately 75 days to approximately 100 days. Illustratively, the period may be approximately 85 days.

The process 100 may also include reminding the applicant of the predetermined activation period for paying the required amount (block 126), if the required amount has not been paid at various predetermined intervals prior to the end of the predetermined activation period. The step of reminding may include sending the applicant a reminder of the requirement to pay the required amount prior to the end of the predetermined activation period in order to open the account. A series of reminders may be sent to the applicant at predetermined intervals if payment of the required amount has not been received and the activation period has not ended.

A communication including a full or partial payment of the required amount may be received from the applicant (block 128). As may be evident from the foregoing, the receipt of the payment preferably occurs prior to the credit card account being opened and typically occurs after the customer has received the credit card object. The communication including the payment may be received from the applicant in any suitable manner, including for example, over a communication network (such as the world wide web or internet) by accessing a designated website 66 maintained by or for the financial institution issuing the credit card.

The process 100 may also include determining if the required amount has been paid (block 130), which may include determining if the payment received from the approved applicant is a full payment of the required amount or a partial payment of the required amount. If the amount of the payment received is less than full payment of the required amount, then the payment amount may be applied to the balance of the required amount due, and the applicant reminded of the balance of the required amount remaining to be paid to open the credit card account. Any notification sent to the applicant to remind the applicant of the activation period (and the time left in the activation period) may include an indication of the remaining balance due on the required amount.

Upon receipt of the full payment of the required amount, or a partial payment with an amount that brings the total of the partial payments to the full amount of the required amount, the credit card account may be opened (block 118) by the financial institution. Opening of the card account may include any step or process or procedure or authorization that enables the credit card account to be utilized by the applicant, such as by using the credit card (object) to make purchases. As the credit card account may have already been set up previously, opening of the account may simply include notifying a credit card processor of the issuance of the credit card for use. As may be apparent from the foregoing, the opening of the credit card account may occur after the credit card object has been provided to the applicant, and after the required amount has been paid, so that the applicant receives the credit card object before the credit card account is open and able to be used by the applicant, and before the required amount is requested and due to be paid. Any defect in the payment of the required amount, such as a returned bank draft or other refusal to honor the payment may result in the opening of the credit card account being withdrawn or rescinded so that the credit card account cannot be accessed by the applicant.

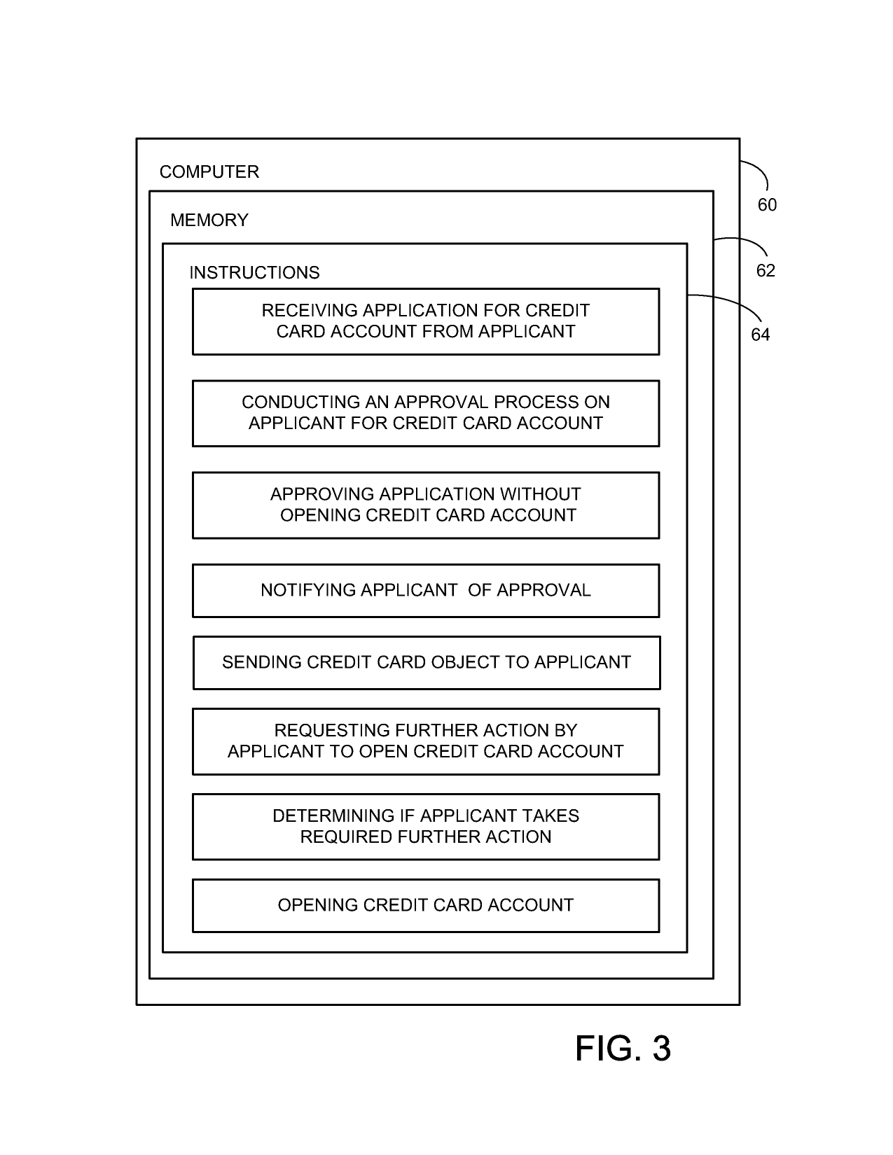

Another aspect of the disclosure relates to a computer program product 64 with instructions for causing a computer system to perform various steps and operations of the methods and processes disclosed herein when the program is loaded into a processor of a computer system from memory. For example, as shown in FIG. 3, a program of instructions may be stored or loaded into memory of the computer system. Illustratively, the program may include instructions for receiving an application for a credit card account from an applicant, conducting an approval process on applicant for a credit card account, approving the application for a credit card account without opening the credit card account, notifying the applicant of the approval of the application, requesting that the application take further action in order to have the credit card account opened, determining if the applicant has taken the required further action, and opening credit card account if the action has been taken.

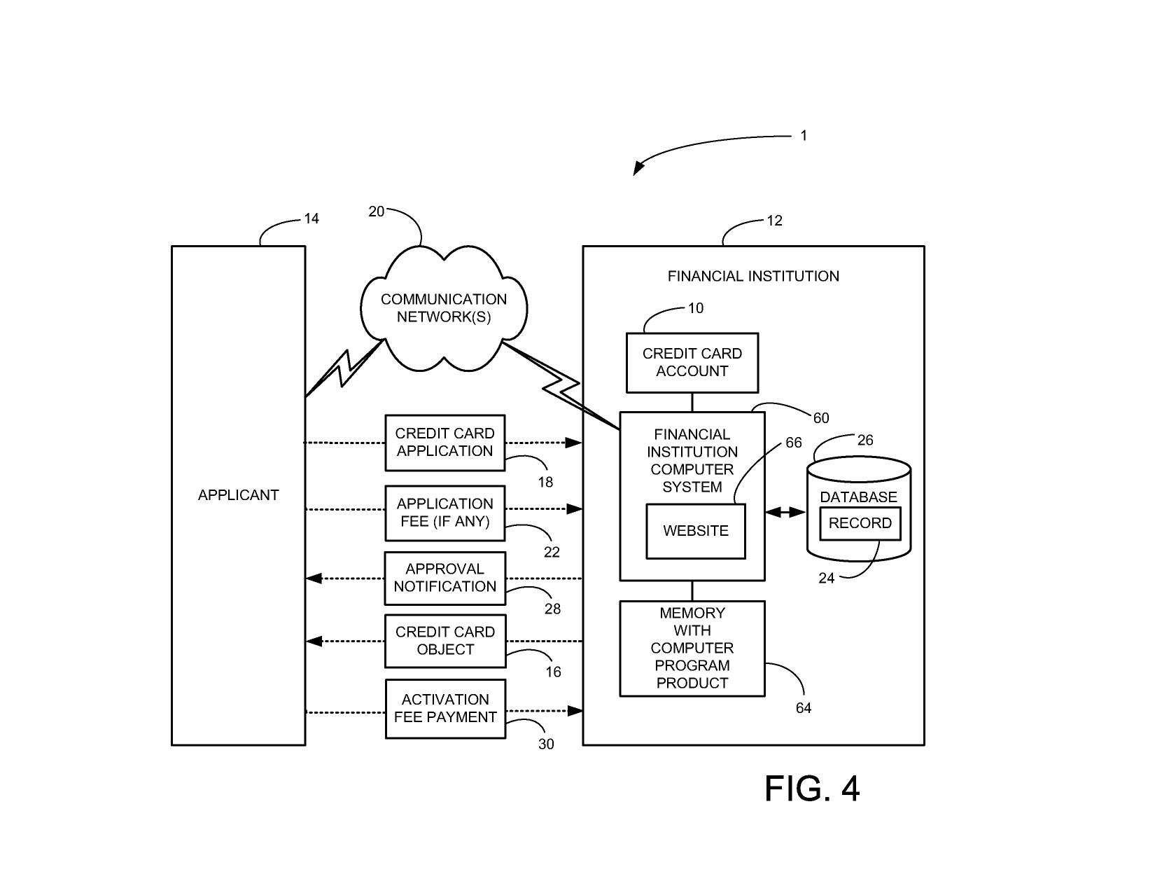

In other aspects of the disclosure, a system 1 for initiating a credit card account may enable and facilitate the processes and methods disclosed herein. An illustrative system 1 such as depicted in FIG. 4 may include a computer system 60 maintained by the financial institution 12 that has access to the database 26 and records 24 that are stored on the database. The computer system 60 may include memory 62 that stores a computer program 64 or programs that operate the computer system to provide the functions to enable the processes and methods disclosed herein. The computer system 60 may also support a website 66 or point of access for applicants through the communication network 20 to, for example, submit an application, monitor the status of an application, as well as submit payment of the various fees. Further, the computer system 60 may provide the means for the financial institution to transmit notifications to the application as well as requests and reminders.

It should be recognized that although the various steps and actions and functions described herein may be described as being taken by specific entities, these steps and actions are not limited to those entities and may be taken by other entities described herein as well as other entities not described.

It should also be appreciated from the foregoing description that, except when mutually exclusive, the features of the various embodiments and implementations described herein may be combined with features of other embodiments as desired while remaining within the intended scope of the disclosure.

With respect to the above description, it should be realized that the relationships for the elements and steps and acts of the disclosed embodiments and implementations may include variations in form, function and manner of operation, assembly and use not specifically stated herein. Such variations are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art based upon this disclosure, it is not desired to limit the disclosed subject matter to the exact construction and operation shown and described, and accordingly, all suitable modifications and equivalents may be resorted to that fall within the scope of the claims.

We claim:

1. A method of initiating a credit card account by a financial institution for an applicant, the method comprising:
receiving an application from an applicant for a credit card account;
conducting an approval process on the application of the applicant for the credit card account;
approving the application of the applicant for the credit card account, wherein approving the application includes assembling data corresponding to the applicant in a credit card database without opening the credit card account;
notifying the applicant of the approval of the applicant for the credit card account;
providing a credit card object associated with the credit card account to the applicant prior to opening the credit card account;
requiring further action to be taken by the applicant before opening the credit card account after notifying the applicant of the approved application for the credit card account;
determining if the required further action has been taken by the applicant; and
if the required further action has been taken by the applicant, opening the credit card account of the applicant to enable use of the credit card object to utilize the credit card account.

2. The method of claim 1 wherein the required further action by the applicant comprises payment of a required amount by the applicant.

3. The method of claim 2 wherein the required amount must be paid in a predetermined activation period or the approval of the application for the credit card account is withdrawn.

4. The method of claim 1 additionally comprising reminding the applicant of the predetermined activation period for paying the required amount prior to an end of the activation period, if the required amount has not been paid prior to the end of the predetermined activation period.

5. The method of claim 1 wherein notifying the applicant of the approval includes requesting payment of a required amount before the credit card account will be opened.

6. The method of claim 1 wherein determining if the further required action has been taken includes receiving payment of a required amount from the applicant for the opening of the credit card account.

7. The method of claim 6 wherein receiving the payment of the required amount for the credit card account occurs after the credit card object has been provided to the applicant and before opening of the credit card account.

8. The method of claim 6 additionally comprising determining if the payment received from the applicant is a full payment of the required amount or a partial payment of the required amount.

9. The method of claim 1 wherein notifying the applicant of the approval includes requesting payment of a required amount before the credit card account will be opened and occurs substantially simultaneously with providing the credit card object to the applicant.

10. The method of claim 1 wherein approving the applicant for the credit card account includes creating a record for the applicant in a credit card account database.

11. A computer program product stored on a tangible computer memory media associated with a first computer and operable on the first computer, the computer program product including instructions executable by the first computer to cause the first computer to perform the steps of:
receiving an application from an applicant for a credit card account;
if the application is approved for the credit card account, assembling data corresponding to the applicant in a credit card database without opening the credit card account;
transmitting a notification to the applicant of the approval of the applicant for the credit card account, wherein the notification includes identification of a further action to be taken by the applicant before the credit card account is opened;
causing a credit card object associated with the credit card account to be transmitted to the applicant prior to opening the credit card account;
determining if the required further action has been taken by the applicant, and
if the required further action has been taken by the applicant, opening the credit card account of the applicant to enable use of the credit card object to utilize the credit card account.

12. The computer program product of claim 11 wherein the required further action by the applicant comprises payment of a required amount by the applicant.

13. The computer program product of claim 12 wherein the required amount must be paid in a predetermined activation period or the approval of the application for the credit card account is withdrawn.

14. The computer program product of claim 11 wherein determining if the further required action has been taken includes receiving payment of a required amount from the applicant for the opening of the credit card account.

15. A system for initiating a credit card account by a financial institution for an applicant, comprising:
a first computer associated with the financial institution, the first computer being communicatively connected to a computer communications network, the first computer including a processor and memory; and
a computer program product stored on a tangible computer memory media associated with the first computer and operable on at least the first computer, the computer program product including instructions executable by at least the first computer to cause the first computer to perform the steps of:
receiving an application from an applicant for a credit card account;
if the application is approved for the credit card account, assembling data corresponding to the applicant in a credit card database without opening the credit card account;
transmitting a notification to the applicant of the approval of the applicant for the credit card account, wherein the notification includes identification of a further action to be taken by the applicant before the credit card account is opened;
causing a credit card object associated with the credit card account to be transmitted to the applicant prior to opening the credit card account;
determining if the required further action has been taken by the applicant, and
if the required further action has been taken by the applicant, opening the credit card account of the applicant to enable use of the credit card object to utilize the credit card account.

16. The system of claim 15 wherein the required further action by the applicant comprises payment of a required amount by the applicant.

17. The system of claim 15 wherein the required amount must be paid in a predetermined activation period or the approval of the application for the credit card account is withdrawn.

18. The system of claim 15 wherein determining if the further required action has been taken includes receiving payment of a required amount from the applicant for the opening of the credit card account.
